(19) United States
(12) Patent Application Publication
(10) Pub. No.: US 2006/0201910 A1
(43) Pub. Date: Sep. 14, 2006

(54) METHODS FOR REMOVING EXTRANEOUS AMOUNTS OF MOLDING MATERIAL FROM A SUBSTRATE

(75) Inventors: James D. Getty, Vacaville, CA (US); Jiangang Zhao, Concord, CA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/420,840

(22) Filed: May 30, 2006

Related U.S. Application Data
(63) Continuation-in-part of application No. 11/021,341, filed on Dec. 22, 2004.

(51) Int. Cl. C03C 15/00

(52) U.S. Cl. 216/57

(57) ABSTRACT

Methods for removing thin layers of extraneous multi-component molding material from one or more areas on a substrate. The methods include exposing the substrate to a plasma effective to remove a non-particulate component of the molding material from each area. The methods further include exposing the substrate to a non-plasma process effective to remove a particulate component of the molding material from the area.

### CROSS-REFERENCE TO RELATED APPLICATIONS

This application is a continuation-in-part of application Ser. No. 11/021,341, filed Dec. 22, 2004, the disclosure of which is hereby fully incorporated by reference herein.

### FIELD OF THE INVENTION

The invention relates generally to plasma processing, and more particularly to treatment methods for removing thin layers of extraneous multi-component molding material from an area on a substrate.

### BACKGROUND OF THE INVENTION

The surface properties of substrates used in applications relating to integrated circuits, electronic packages, and printed circuit boards are commonly modified by plasma treatment. In particular, plasma treatment is used in electronics packaging, for example, to increase surface activation and/or surface cleanliness for eliminating delamination and bond failures, improving wire bond strength, ensuring void free underfilling of chips on circuit boards, removing oxides, enhancing die attach, and improving adhesion for die encapsulation. Typically, one or more substrates are placed in a plasma treatment system and at least one surface of each substrate is exposed to the plasma. The outermost atomic layers may be removed from the surface by physical sputtering, chemically-assisted sputtering, chemical reactions promoted by reactive plasma species, and combinations of these mechanisms. The physical or chemical action may also be used to condition the surface to improve properties such as adhesion or to clean undesired contaminants from the substrate surface.

During semiconductor manufacture, semiconductor die are commonly electrically coupled by wire bonds with leads on a metal carrier, such as a lead frame. Lead frames generally include a number of pads each having exposed leads used to electrically couple a single semiconductor die with a circuit board. One semiconductor die is attached to each pad and external electrical contacts of the die are wire bonded with nearby portions of the leads.

Each semiconductor die and its wire bonds are encapsulated inside a package consisting of a molded polymer body designed to protect the semiconductor die and wire bonds from the adverse environment encountered during handling, storage and manufacturing processes as well as to dissipate the heat generated from the semiconductor die during operation. A common multi-component molding material used to fabricate such packages is an epoxy resin matrix filled with silica or silicon particulates or particles.

During the molding process, the lead frame and the multiple attached semiconductor die are positioned between two mold halves. One mold half includes numerous cavities each receiving one of the semiconductor die and defining the package shape. The mold halves are pressed together in an attempt to seal the entrance mouths to the cavities. The molding material, which is injected into the mold, fills the open space inside the cavities for encapsulating the semiconductor die and wire bonds. However, molding material can seep out of the cavities between the mold halves and form thin layers or flash on the exposed leads. This thin flash has a thickness typically less than about 10 microns. Flash is detrimental as it may affect the ability to make high quality electrical connections with the encapsulated semiconductor die.

Flash may be prevented during the molding process by covering the backside of the lead frame with tape. However, adhesive may be transferred from the tape to the lead frame backside and remain as a residue after the tape is removed. In addition, tapes suitable for this application are relatively expensive, which adds to the cost of manufacture, and tape application and removal incurs require labor costs and slows process throughput.

Flash may be removed after molding by mechanical and chemical techniques, or with a laser. These removal approaches also suffer from deficiencies that restrict their use. For example, the lead frame is susceptible to damage from mechanical flash removal techniques, such as chemical mechanical polishing. Chemical processes may be ineffective unless highly corrosive chemicals are used, which potentially raises issues of worker safety and waste disposal of the spent corrosive chemicals. Laser removal is expensive and leaves a residual carbon residue behind on the lead frame.

For at least these reasons, there is thus a need for a treatment process that can efficiently and effectively remove extraneous molding material from a substrate.

### SUMMARY OF THE INVENTION

Embodiments of the invention address these and other problems associated with conventional flash removal processes. To that end and with regard to an embodiment of the invention, a method is provided for removing amounts of a molding material from an area on a substrate. The substrate is exposed to a plasma effective to substantially remove a non-particulate component of the molding material from the area. The substrate is then exposed to a non-plasma process effective to remove a particulate component of the molding material from the area.

In one specific embodiment of the invention, the non-plasma process further comprises brushing the molding material in the area of the substrate to remove the particulate component of the molding material from the area. In another specific embodiment of the invention, the non-plasma process further comprises placing the molding material in the area of the substrate in contact with a cleaning solution effective to remove the particulate component of the molding material from the area.

These and other advantages of the invention shall become more apparent from the accompanying drawings and description thereof.

### BRIEF DESCRIPTION OF THE FIGURES

The accompanying drawing, which is incorporated in and constitutes a part of this specification, illustrates an embodiment of the invention and, together with a general description of the invention given above, and the detailed description given below, serves to explain the principles of the invention.

FIG. 1 is a diagrammatic view of a plasma treatment system for plasma treating substrates in accordance with the invention.

FIG. 2 is a diagrammatic view of a cleaning station for use with the plasma treatment system of FIG. 1 in accordance with an alternative embodiment of the invention.

### DETAILED DESCRIPTION OF THE PREFERRED EMBODIMENTS

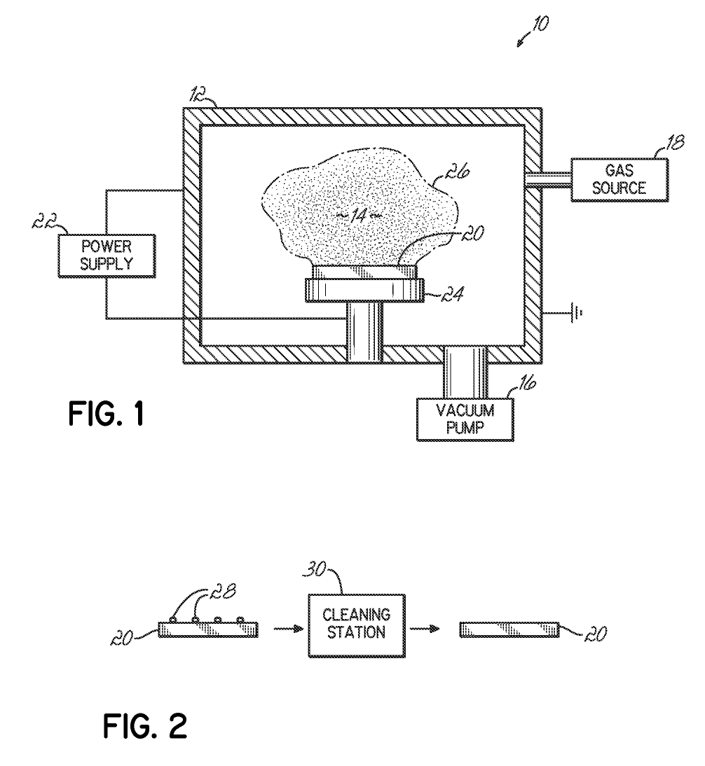

With reference to FIG. 1, a plasma treatment system 10 includes a treatment chamber 12 constituted by walls that enclose a processing space 14. During plasma processing, the treatment chamber 12 is sealed fluid-tight from the surrounding ambient environment. The treatment chamber 12 includes an access opening (not shown) configured for a transferring substrate 20 to and from the processing space 14. A vacuum pump 16 used to evacuate the processing space 14 of treatment chamber 12 may comprise one or more vacuum pumps with controllable pumping speeds as recognized by persons of ordinary skill in the art of vacuum technology. Process gas is admitted to the processing space 14 from a process gas source 18 through an inlet port defined in the treatment chamber 12 at a predetermined flow rate. The flow of process gas from the process gas source 18 to the processing space 14 is typically metered by a mass flow controller (not shown). The flow rate of gas from the process gas source 18 and the pumping rate of vacuum pump 16 are adjusted to provide a processing pressure and environment suitable for plasma generation. Processing space 14 is continuously evacuated simultaneously as process gas is introduced from the process gas source 18 so that fresh gases are continuously exchanged within the processing space 14 when the plasma is present.

A power supply 22 is electrically coupled with, and transfers electrical power to, an electrode pedestal 24 inside of the treatment chamber 12, which supports substrate 20 in the exemplary treatment system 10. Power transferred from the power supply 22 is effective for forming a plasma 26 proximate to the substrate 20 from the process gas confined within processing space 16 and also controls the direct current (DC) self-bias. Although the invention is not so limited, the power supply 22 may be a radio-frequency (RF) power supply operating at a frequency between about 40 kHz and about 13.56 MHz, preferably about 13.56 MHz although other frequencies may be used, and a power level, for example, between about 4000 watts and about 8000 watts at 40 kHz or 300 watts to 2500 watts at 13.56 MHz. However, those of ordinary skill in the art will appreciate that different treatment chamber designs may permit different bias powers. A controller (not shown) is coupled to the various components of the plasma treatment system 10 to facilitate control of the etch process.

Plasma treatment system 10 may assume different configurations understood by those of ordinary skill in the art and, therefore, is not limited to the exemplary configuration described herein. For example, the plasma 26 may be generated remote of treatment chamber 12 and delivered to the processing space 14 for use in plasma treating substrate 20. Plasma treatment system 10 is further understood to include components not shown in FIG. 1 necessary for operation of system 10, such as a gate valve disposed between the processing space 14 and the vacuum pump 16.

Substrate 20 is positioned in the processing space 14 of treatment chamber 12 at a location suitable for plasma treatment. The invention contemplates that multiple substrates 20 may be positioned inside treatment chamber 12 and treated simultaneously with the plasma 26 provided in processing space 14 by a single treatment process.

The plasma treatment of substrate 20 efficiently and effectively removes thin layers of molding material (i.e., flash) disposed on areas of the substrate 20. The flash-covered areas may be created by a molding process during a previous manufacturing stage. For example, these areas of extraneous molding material may reside on electrical contacts for a semiconductor die encapsulating inside a molded polymer package. A common molding material is a composite consisting of an organic matrix, like polymer or epoxy, and an inorganic filler, like silica particles, dispersed in the matrix for modifying a property of the organic matrix.

The plasma treatment of substrate 20 is a two stage process based upon the premise that the etch selectivity and etch rate of the organic matrix and the inorganic filler constituting the molding material differ under equivalent plasma conditions. The use of two distinct process stages accelerates flash removal as the first stage is adapted to efficiently remove the organic matrix selectively to the inorganic filler and the second stage is adapted to efficiently remove the inorganic filler selectively to the organic matrix. One approach for providing these two process stages is to vary the composition of the gas mixture from which the plasma is formed.

In the first stage of the process, the substrate 20 in processing space 14 is exposed to a plasma 26 formed from an oxygen-rich gas mixture including a fluorine-containing gas species (e.g., carbon tetrafluoride, nitrogen trifluoride, or sulfur hexafluoride) and an oxygen-containing gas species, like oxygen (O₂). Although not wished to be bound by theory, it is believed that active species (e.g., radicals and ions) of oxygen from the plasma 26 are relatively effective for removing the organic matrix in the areas on substrate 20 covered by the thin layer of molding material. Similarly, it is believed that active species of fluorine originating from the plasma 26 are relatively effective for removing the inorganic filler of the molding material. By forming the plasma 26 from an oxygen-rich gas mixture, the etch rate for the organic matrix is greater than the etch rate for the inorganic filler. In other words, the organic matrix is removed selective to the inorganic filler.

As described above, the concentration by volume of the oxygen-containing gas species in the gas mixture of the first process stage is greater than the concentration by volume of the fluorine-containing gas species. As a result, the gas mixture for the first process stage includes the oxygen-containing gas species at a concentration of more than 50 percent by volume (vol %). The fluorine-containing gas species typically comprises the balance of the gas mixture, although other gas species like an inert gas may be deliberately added to the gas mixture so long as the oxygen-containing gas species has a greater concentration than the fluorine-containing species. Of course, residual atmospheric gases and out-gassing from chamber components also contribute partial pressures to the partial vacuum inside treatment chamber 12. Gas mixtures most suitable for use in the first process stage include about 70 vol % to about 90 vol % of the oxygen-containing gas species. A gas mixture found to be particularly suitable for this initial process stage of the process is 80 vol % of the oxygen-containing gas species and 20 vol % of the fluorine-containing gas species.

Active species of oxygen present in the plasma 26 of the first stage efficiently remove the organic matrix in the areas on substrate 20 covered by the thin layer of molding material. Although active species of fluorine remove the inorganic filler in these flash-covered areas, the recipe of the first stage is relatively inefficient for removing the inorganic filler due to the relatively low etch rate for this component of the molding material. As a result, after the organic matrix is substantially or partially removed from the spaces between the filler, residual inorganic filler remains across areas of substrate 20 formerly covered by flash. The invention contemplates that because the second stage also removes the organic matrix, albeit with a significantly lower etch rate, the organic matrix does not have to be completely removed during the first stage of the treatment process and may be partially removed by the second process stage. Of course, the two process stages may be iterated for flash removal, if required.

In a second process stage of the treatment process, the substrate 20 in processing space 14 is exposed to a plasma 26 generated from a fluorine-rich gas mixture of a fluorine-containing species (e.g., carbon tetrafluoride, nitrogen trifluoride, or sulfur hexafluoride) and an oxygen-containing gas species, like oxygen (O₂). The plasma 26 formed from this gas mixture has an elevated etch rate for the inorganic filler relative to the etch rate for the organic matrix, as compared with the first process stage. Typically, the change in the gas mixture is accomplished without breaking vacuum and, preferably, without extinguishing the plasma 26 inside treatment chamber 12. This second gas mixture may include the same two gas species as the first stage but mixed in different relative proportions.

Generally, the concentration by volume of the oxygen-containing gas species in the gas mixture is smaller than the concentration by volume of the fluorine-containing gas species. Typically, the gas mixture for the second stage includes less than 50 vol % of the oxygen-containing gas species and the balance of the mixture comprises the fluorine-containing gas species. However, other gas species like an inert gas may be deliberately added to the gas mixture so long as the oxygen-containing gas species has a smaller concentration than the fluorine-containing species. Gas mixtures most suitable for use in the second process stage comprise about 70 vol % to about 90 vol % of the fluorine-containing gas species. A gas mixture found to be particularly suitable for this stage of the process is 20 vol % of the oxygen-containing gas species and 80 vol % of the fluorine-containing gas species.

The active species in the plasma 26 generated from the fluorine-rich gas mixture of the latter process stage remove the residual inorganic filler more efficiently than the plasma 26 generated from the oxygen-rich gas mixture of the first process stage. As a result, the overall process time required to remove flash from the affected areas on the substrate 20 is reduced as compared with a one stage process using only a single gas mixture that has a higher etch rate for only one component of the molding material. This overall reduction in process time contributed by the two stage process of the invention significantly increases system throughput.

Portions of the substrate 20 susceptible to plasma damage may be covered during the plasma treatment to prevent or significantly reduce plasma exposure. The exposure time for each of the stages will depend upon, among other variables, the plasma power, the properties of the treatment chamber 12, and the characteristics of the flash, such as thickness. The etch rate and process uniformity will be contingent upon plasma parameters, including but not limited to input power, system pressure, and processing time.

The invention overcomes the various deficiencies of conventional removal techniques as thin areas of molding material are removed without resort to wet chemical etching techniques, mechanical techniques, or the use of a laser. The process recipe of the invention is particularly applicable for removing unwanted thin layers of molding material or flash covering the electrical contacts of a lead frame. These thin layers result from the molding process encapsulating die carried by the lead frame inside respective packages constituted by the molding material.

In use and with reference to FIG. 1, the substrate 20 is positioned in the processing space 14 inside the treatment chamber 12 at a location suitable for plasma processing. The processing space 14 is then evacuated by vacuum pump 16. During both process stages, a flow of process gas is introduced from process gas source 18 to raise the partial vacuum in the treatment chamber 12 to a suitable operating pressure, typically in the range of about 150 mTorr to about 2500 mTorr and preferably in the range of about 800 mTorr to 2500 mTorr for providing an enhanced etch rate, while actively evacuating the processing space 14 with vacuum pump 16. The power supply 22 is energized for supplying electrical power to the electrode pedestal 24, which generates plasma 26 in the processing space 14 proximate to the substrate 20 and DC self-biases the electrode pedestal 24.

The substrate 20 is exposed to the plasma in a two-stage treatment process for individual stage exposure times sufficient for removing the excess molding material in the form of flash from areas on the substrate 20. Specifically, the substrate 20 is exposed to a first plasma generated from the oxygen-rich gas mixture of an oxygen-containing gas species and a fluorine-containing gas species for a duration sufficient to substantially remove the organic matrix of the flash. During this first stage removing the non-particulate component of the molding material, the etch rate for the organic matrix is greater than the etch rate for the inorganic filler. Then, the substrate 20 is exposed to a second plasma generated from the fluorine-rich gas mixture of an oxygen-containing gas species and a fluorine-containing gas species for a duration sufficient to substantially remove the inorganic filler of the flash. During this second stage removing the particulate component of the molding material, the etch rate for the inorganic filler is greater than the etch rate for the organic matrix.

The substrate 20 may be exposed to the first and second plasmas 26 without removing the substrate 20 from the treatment chamber 12 (i.e., without extinguishing the plasma as the process gas mixture is changed). Preferably, the substrate 20 remains in the same treatment position during both stages of the treatment process. The two process stages may be iterated or repeated as needed to accomplish flash removal, which may be contingent upon the flash thickness. The plasma 26 is extinguished after the completion of the second stage of the treatment process. However, there may be additional plasma processing steps unrelated to flash removal either before or after the power is turned off.

With reference to FIG. 2 and in an alternative embodiment of the invention, the second plasma-based process stage of the treatment process may be replaced by a non-plasma based process, such as a chemical process, a mechanical process, or a combination of chemical and mechanical processes. Particles 28, which are constituted by the inorganic filler (i.e., particulate component of the molding material), remain on an area of the substrate 20 following the conclusion of the first process stage substantially removing the organic matrix. After the organic matrix is removed, the particles 28 are readily accessible for removal by such chemical and/or mechanical processes.

Particles 28 may be substantially removed by exposing the substrate 20 to the environment of a cleaning station 30. Advantageously, substantially all of the particles 28 from the molding material may be removed in the cleaning station 30 to provide an area on the substrate surface that is substantially free of particles 28, without introducing a significant density of defects to the substrate surface. The cleaned substrate area may comprise the entire substrate surface or a portion of the total surface area. Residual amounts of the organic matrix may remain adhered to the particles 28 after the conclusion of the first process stage of the treatment process and, hence, removed by the non-plasma process.

The cleaning station 30 may include a scrubber constituted by one or more brushes that at least partially remove the particles 28 from substrate 20 by a brushing process. The substrate 20 is held in the cleaning station 30 such that the surfaces bearing particles 28 are unobstructed, which provides access for cleaning. Each brush of the scrubber has bristles, typically formed from a polymer like polyvinyl acetate (PVA), that contact the surface of the substrate 20 bearing the particles 28 and sweep the particles 28 from the surface. The pressure applied by the brush bristles to the substrate 20 is sufficiently low such that the substrate 20 is undamaged by scratches and the like arising from the brushing action. However, the pressure applied by the bristles to the substrate 20 should be sufficient to increase the contact between the particles 28 and the brush to a point where the associated adhesion forces can be overcome.

The brushes may be, for example, power-driven cylindrical brushes that have radially-projecting bristles that present a cylindrical brushing surface. The substrate 20 may be conveyed between a pair of such cylindrical brushes so that the brushing action is two-sided or, alternatively, only one side of the substrate 20 may be contacted by the bristles. The brushes may alternatively be spinning pads having an array of substantially parallel bristles that contact one or both sides of the substrate 20 and present a planar brushing surface. If one side of the substrate 20 does not require brushing, then the brushing action may be restricted to the side of the substrate 20 contaminated with particles 28.

The brushing action may be assisted or otherwise augmented by vacuum or suction that lifts the loosened particles 28. The brushes may also be configured to deliver a stream of cleaning solution to the substrate 20 for fluid assisted removal of loosened particles 28. Heat may also serve to add to or boost particle removal. Other types of constructions capable of wiping the particles 28 from the substrate 20 are contemplated by the invention.

While exposed to the environment of the cleaning station 30, the substrate 20 may be supported by a tray or fixture (not shown). Fixtures suitable for use during plasma treatment in the plasma treatment system 10 and subsequently suitable for use during particle removal in the cleaning station 30 are disclosed in commonly-assigned U.S. application Ser. No. 11/003,062, which is hereby incorporated by reference herein in its entirety. Alternatively, different fixtures may be used in the plasma treatment system 10 and cleaning station 30. The substrate 20 may be conveyed from the treatment chamber 12 and introduced into the cleaning station 30 while residing on the fixture.

Other dry processes that do not rely on a liquid cleaning agent and that do not rely on contact may be used in cleaning station 30 for removing at least a portion of the particles 28 from substrate 20. In a dry process alternative embodiment of the invention, the cleaning station 30 may include one or more high-pressure air jets that direct streams of air or other gas that impinge the substrate 20. Impingement of the air streams with the substrate 20 operates to remove the particles 28. In another dry-process alternative embodiment, the cleaning station 30 may include a laser capable of ablating particles 28 with a beam of radiation having a wavelength appropriate to vaporize the particles 28. A reactive gas, such as fluorine, may be directed to an area around the beam to facilitate a chemical reaction between the laser radiation and the particles 28.

In yet another dry-process alternative embodiment, the cleaning station 30 may include an infrared heating device that removes the residual particles of inorganic filler by tuning the frequency of the infrared radiation to match the vibrational frequency of the constituent material of the particles, which heats the particles 28 selective to the substrate 20. The particles 28 are heated in this manner to a vaporization temperature for removal as volatile substances. In another dry-process alternative embodiment, the cleaning station 30 may include a CO₂ or argon cryogenic spray device that removes the particles 28 by physical force involving momentum transfer from the sprayed substance to the particles 28. If the particles 28 are charged, and in another dry process alternative embodiment, the cleaning station 30 may include a device effective to either remove or reverse the electrostatic charge on the particles 28. This may promote removal of the particles 28 by reducing the attractive forces acting between the particles 28 and the substrate 20. In yet another dry-process alternative embodiment, the cleaning station 30 may apply vacuum or suction effective for removing the particles 28.

The particles 28 may also be removed by a removal technique that generally relies on a liquid agent to perform surface cleaning that rids the substrate 20 of the residual particles 28 of inorganic filler. To that end and in an alternative embodiment of the invention, the cleaning station 30 may include a showerhead that sprays a shower of a cleaning solution onto the substrate 20. The showerhead may consist of one or more individual nozzles each emitting a stream of the cleaning solution to impinge the substrate 20. The cleaning solution may be water, preferably deionized or ultrapure, and may contain a dissolved additive, such as a surfactant that may prevent reattachment or re-deposition of particles 28 on the substrate 20 after they have been dislodged from the substrate 20. The cleaning solution may also comprise an aqueous acid solution, such as buffered hydrofluoric acid, or an organic solvent. The cleaning solution wets the substrate 20 and, as the cleaning solution flows across and drains from the substrate 20, transports or flushes at least a portion of the particles 28 from the surface of the substrate 28. The flow of the cleaning solution may be promoted by spinning the substrate 28. The spent cleaning solution may be discarded to a drain or collected in a catch basin inside the cleaning station 30 for filtering to remove the particles 28 so that the cleaning solution may be recycled. Residual cleaning solution on the substrate 20 may be removed by air-drying or by a thermally assisted drying process in a dryer, and may include spinning to promote liquid removal.

The cleaning action of the cleaning solution sprayed onto the substrate 20 may be augmented by the application of sonic or acoustical pressure waves to the cleaning solution from one or more sonic or acoustical transducers associated with the cleaning station 30. The transducers may be focused for selective delivery or unfocused for broad-area delivery. The acoustical pressure waves overcome particle adhesion forces to promote removal of particles 28 from substrate 20 and may operate to push the particles 28 away from substrate 20 to reduce or prevent reattachment. Applying acoustical pressure waves to the cleaning solution may particularly enhance particle removal if the surface of substrate 20 has prominent topography. The acoustical pressure waves may be in an ultrasonic frequency range between about 20 kHz to about 400 kHz or in a megasonic frequency range between about 350 and 1 MHz.

In an alternative embodiment of the invention, the cleaning station 30 may include a tank filled with a bath of a cleaning solution. The substrate 20 is immersed in the bath for a duration sufficient to remove at least a significant portion of the particles 28 from the particulate-laden area on the substrate 20. While immersed, the substrate 20 may be rotated, oscillated, or otherwise moved within the bath to further promote particle cleaning. The substrate 20 may be partially immersed in the bath or completely submerged in the bath, as required to clean the particles 28. The removed particles 28 may be suspended in the bath or may accumulate in a portion of the tank. Among other factors, the cleaning effectiveness will depend upon the temperature and chemistry of the cleaning solution and the immersion time.

The cleaning station 30 may further include an acoustical or sonic transducer communicating with the bath for performing non-contact cleaning. After the substrate 20 is immersed into the cleaning solution of the bath, the substrate 20 is exposed to high-frequency acoustical pressure waves from the transducer for a time sufficient to promote cleaning by dislodging at least a portion of the particles 28 from the substrate 20. The acoustical pressure waves propagate in the bath from the transducer through the transfer medium defined by the cleaning solution to the substrate 20 bearing particles 28. The acoustical pressure waves transfer energy to the substrate 20 and the particles 28 of residual inorganic filler useful in cleaning and dislodging the residual particles 28 of inorganic filler from the substrate 20. The frequency of the operation for the transducer (and thus the frequency of the acoustical waves) is selected to promote efficient agitation and particle removal. The acoustical pressure waves may be in an ultrasonic frequency range between about 20 kHz to about 400 kHz or in a megasonic frequency range between about 350 kHz and 1 MHz. Suitable transducers include, but are not limited to, piezoelectric devices. Among other factors, the cleaning effectiveness may depend upon the intensity of the pressure waves, the temperature and chemistry of the cleaning solution, the cleaning time, and substrate orientation.

In another alternative embodiment of the invention, the cleaning station 30 may include a polishing pad carrying a liquid cleaning agent in the form of a slurry effective for removing particles 28. The slurry may comprise a liquid chemical carrier that interacts chemically with the particles 28 and abrasive particulates carried in the chemical carrier that cooperate with motion of the polishing pad relative to the substrate 20 for removing the residual particles 28 of inorganic filler material. The slurry constituents are precisely selected and controlled in order to remove the residual particles 28 of inorganic filler material while removing minimal amounts of material from the surfaces of the substrate 20.

These non-plasma techniques for removing the residual particles 28 of inorganic filler material may have the benefit of reducing the overall processing time for complete flash removal. As a result, process throughput may be improved.

Further details and embodiments of the invention will be described in the following example.

### EXAMPLE

A lead frame carrying a number of molded packages and with flash observable on the electrical leads of the lead frame was treated with a two-stage plasma process in accordance with the invention. The molding material used to fabricate the packages was a silica-filled epoxy. The first process stage used a gas mixture, measured in terms of flow rate into the plasma chamber, of CF₄ (80 sccm) and O₂ (320 sccm) to form a plasma at a chamber pressure of 400 mTorr. The lead frame was exposed to the plasma for approximately five (5) minutes. The plasma power was about 500 watts at an operating frequency of 13.56 MHz. Upon inspection of the lead frame, the first stage was observed to effectively remove the epoxy in the thin areas.

After the epoxy was removed, the silica filler remained behind on the lead frame as a residue. With the lead frame still inside the treatment chamber and without extinguishing the plasma or breaking vacuum, the gas mixture was transitioned to conform with a second stage of the treatment process. The second stage then used a gas mixture of CF₄ (240 sccm) and O₂ (60 sccm), which again resulted in a chamber pressure of 400 mTorr. The lead frame was exposed to this plasma for approximately five (5) minutes. The plasma power was about 500 watts at an operating frequency of 13.56 MHz. Following this stage of the treatment, the silica filler was removed and the lead frame was observed to be substantially free of flash.

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein we claim:

1. A method for removing amounts of a molding material having a particulate component and a non-particulate component from an area on a substrate, the method comprising:
exposing the substrate to a plasma effective to remove the non-particulate component of the molding material from the area; and
exposing the substrate to a non-plasma process effective to remove the particulate component of the molding material from the area.

2. The method of claim 1 wherein exposing the substrate to the non-plasma process comprises:
contacting the molding material in the area with a cleaning solution effective to remove the particulate component from the area.

3. The method of claim 2 wherein contacting the molding material in the area with the cleaning solution further comprises:
providing sonic wave energy to the cleaning solution for enhancing removal of the particulate component from the area.

4. The method of claim 2 wherein contacting the molding material in the area with the cleaning solution further comprises:
brushing the molding material in the area while the molding material is in contact with the cleaning solution.

5. The method of claim 2 wherein contacting the molding material in the area with the cleaning solution further comprises:
contacting the molding material in the area with de-ionized water.

6. The method of claim 2 wherein contacting the molding material in the area with the cleaning solution further comprises:
at least partially immersing the substrate in a bath of the cleaning solution to wet the area with the cleaning solution.

7. The method of claim 2 wherein contacting the molding material in the area with the cleaning solution further comprises:
submerging the substrate in a bath of the cleaning solution.

8. The method of claim 2 wherein contacting the molding material in the area with the cleaning solution further comprises:
spraying the molding material in the area with the cleaning solution.

9. The method of claim 2 wherein contacting the molding material in the area with the cleaning solution further comprises:
flowing the cleaning solution across the molding material in the area.

10. The method of claim 1 wherein exposing the area of the substrate to the non-plasma process comprises:
brushing the molding material in the area to remove the particulate component from the area.

11. The method of claim 1 wherein exposing the area of the substrate to the non-plasma process comprises:
impinging molding material in the area with one or more high pressure air jets that remove the particulate component from the area.

12. The method of claim 1 wherein exposing the area of the substrate to the non-plasma process comprises:
directing a beam of radiation from a laser at the molding material in the area of the substrate for vaporizing the particulate component.

13. The method of claim 12 further comprising:
supplying a reactive gas to the area to promote chemical reactions between the beam of radiation and the particulate component.

14. The method of claim 1 wherein exposing the area of the substrate to the non-plasma process comprises:
directing infrared radiation to the molding material in the area to promote heating of the particulate component.

15. The method of claim 1 wherein exposing the area of the substrate to the non-plasma process comprises:
directing a cryogenic fluid to the molding material in the area of the substrate.

16. The method of claim 1 wherein exposing the area of the substrate to the non-plasma process comprises:
removing or reversing an electrostatic charge on the particulate component in the area.

17. The method of claim 1 wherein exposing the area of the substrate to the non-plasma process comprises:
contacting the molding material in the area with a polishing pad and a slurry carried on the polishing pad that are effective for removing the particulate component from the area.
